(19) United States
(12) Patent Application Publication
(10) Pub. No.: US 2008/0067294 A1
(43) Pub. Date: Mar. 20, 2008

(54) Cable bushing assembly

(76) Inventors: Uwe Heller, Bad Windsheim (DE); Werner Lang, Ergersheim (DE); Manfred Herrler, Schwabach (DE)

Correspondence Address: MCNAIR LAW FIRM, P.A., P.O. BOX 10827, GREENVILLE, SC, 29603-0827, US

(21) Appl. No.: 11/899,802

(22) Filed: Sep. 7, 2007

(30) Foreign Application Priority Data
Sep. 8, 2006 (DE) 10 2006 042 192.2

(51) Int. Cl. F16L 5/10; E04B 1/34

(52) U.S. Cl. 248/56; 52/3

(57) ABSTRACT

A cable bushing assembly and panel mount is disclosed comprising a bushing opening in the panel having a first area with a first width and a first length, and a second area with a second width and a second length wherein the first width is greater than the second width. The second area has opposed side edges providing fastening edges. A cable sleeve fitting is provided for mounting in the cable opening of a cable carried by the sleeve fitting. The sleeve fitting includes a flange cover through which the cable is routed and which generally overlays the cable bushing opening. A fastening part is carried by the sleeve fitting having a width generally equal to, or less than, the first width of the first area and generally greater than the second width of the second area of the cable bushing opening.

### BACKGROUND OF THE INVENTION

The present invention concerns a cable bushing assembly having a cable sleeve fitting and a panel having a corresponding cable bushing opening for mounting, particularly in a vehicle application.

Cable bushings as well as cable sleeve fittings are known in a multitude of different designs. In the automotive area, the purpose is to bring electrical wiring with electrical or electronic components through housings or partitions. In this service it is necessary that a cable bushing be equipped to resist external stresses, be of small dimensioning, provide protection for a contained cable, be sealed against moisture, and finally, be capable of being mounted or dismounted with the least possible effort. Known cable bushings and associated fittings so described, for instance, those such as have been marketed by the firm Hellermann Tyton, do not, currently, fulfill the given requirements to a sufficient extent.

Accordingly, it is an object of the present invention to make available a cable bushing assembly having a cable with a sleeve fitting, which meet the various demands of the automotive industry in a greater measure than heretofore. Further, the purpose of the invention is to furnish a partition, or a cover panel, which has an opening complementary to mounting the bushing assembly.

### SUMMARY OF THE INVENTION

Due to the shape of the opening to accommodate the cable bushing, which has different width functional surfaces, it is possible that a correspondingly shaped cable sleeve fitting can be easily inserted into a recess thereof and by means of a clamping closure between the recess and the fastening edges of the cable bushing, can be securely held. By means of the dimensioning and the physical arrangement of the housing panel, where the cable is concerned, a moisture tight seal is created for the cable bushing. The shape of the housing panel and of the fastening component, as seen in top view, can be optional, that is it may optionally appear as an rectangle, an oval, a circle or the like.

The invention adapts itself particularly well for cable bushings carrying large plug connectors. That is, the cross-section of the plug-in connector is larger than that of the cable, whereby equipment is made which is usually difficult to properly seal off. By means of the invented shape of the bushing opening, where the areas of the bushing and the opening provide sufficient room, so that even large plug-in components can be passed through the available aperture.

In accord with an advantageous embodiment of the invention, the cable bushing opening is embedded in a recess, of depth to be defined later. For this reason, the flat outline of the recess is complementary to the outer contour of a flange cover, which is part of the outer wall of the fitting, by means of which the sealing tightness of the cable bushing is considerably improved.

Advantageously, a thickness of the edge surfaces of the flange cover is equal to the depth of the recess. By this advantage the upper edge of the recess aligns itself with the external side of the flange cover with the consequence that a loose flapping action of the cover is avoided.

In accord with an advantageous embodiment of the invention, the fastening edges run parallel to one another and form consequently one plane. This arrangement assures a simple mode of manufacture and gives an assured grip of the cable sleeve fitting between the two fastening edges by a clamping means.

In a similar manner, the advantageous formation of the invented object, parallel edges of the fastening edges lie in the one plane of the first area of the cable bushing opening, enabling a problem-free manufacturing operation.

In accord with an advantageous embodiment of the invention, between the first and the second area of the cable bushing opening, an opening is provided which lends itself to a special, convergent transition area. Through this transition opening, the insertion and the clamping of the cable sleeve fitting is made easier in the second area between the two fastening edges.

In accord with another advantageous embodiment of the invention, the shape of the second area (when seen in plan view) of the cable bushing opening is complementary to the external shape of the fastening part of the cable sleeve fitting. By means of this arrangement, as a first consideration, an easy insertion of the connector plug into the first area is assured and at the same time, no space is unnecessarily wasted.

In an advantageous manner, in this arrangement, the second area and the fastening part are made as rectangles. In this way, the manufacturing procedure is simplified.

In accord with an advantageous embodiment of the invention, the depth of indentation areas in the fastening zone on the forward end in an insertion direction of the fastening device is increasing in depth. In this way, the insertion and the securement of the cable connector is made easier at the second area of the cable bushing opening.

In accord with another advantageous embodiment of the invention, the flange cover is penetrated by the cable in an eccentrically offset location. Accordingly, when the cable sleeve fitting is completely inserted into the second area, then the flange cover can make a tight closure of the bushing opening. Since the cable bushing opening lies in the recess, the flange cover lies in the same recess.

### DESCRIPTION OF THE DRAWINGS

The invention will be more readily understood from a reading of the following specification and by reference to the accompanying drawings forming a part thereof, wherein an example of the invention is shown and wherein:

FIG. 1 is a perspective presentation of an embodiment of a cable bushing assembly according to the invention, whereby the cable is shown with a sleeve fitting not inserted in the cable bushing opening;

FIG. 2a is a plan view of the cable bushing opening; and

FIG. 2b is a sectional view along the line A-A of 2a;

FIG. 3a is a plan view of the cable sleeve fitting from the side of the plug connector;

FIG. 3b is a sectional view along the cable, as seen in profile;

FIG. 3c is a sectional view along the cable, as seen from above or beneath;

FIG. 4a is a perspective presentation of a cable sleeve fitting inserted in the first area of the cable bushing opening, with the cable entering from the outside;

FIG. 4b is a perspective presentation of a cable sleeve fitting inserted in the first area of the cable bushing opening, with the cable entering from the inside;

FIG. 5a is a perspective presentation with half of a cable sleeve fitting inserted into the second area of the cable bushing opening with the cable entering from the outside;

FIG. 5b is a perspective presentation with half of a cable sleeve fitting inserted into the second area of the cable bushing opening with the cable entering from the inside;

FIG. 6a is a perspective presentation with an entire cable sleeve fitting inserted into the second area of the cable bushing opening with the cable entering from the outside; and

FIG. 6b is a perspective presentation with an entire cable sleeve fitting inserted into the second area of the cable bushing opening with the cable entering from the inside.

### DESCRIPTION OF A PREFERRED EMBODIMENT

Referring now in more detail to the drawings, the invention will now be described in more detail.

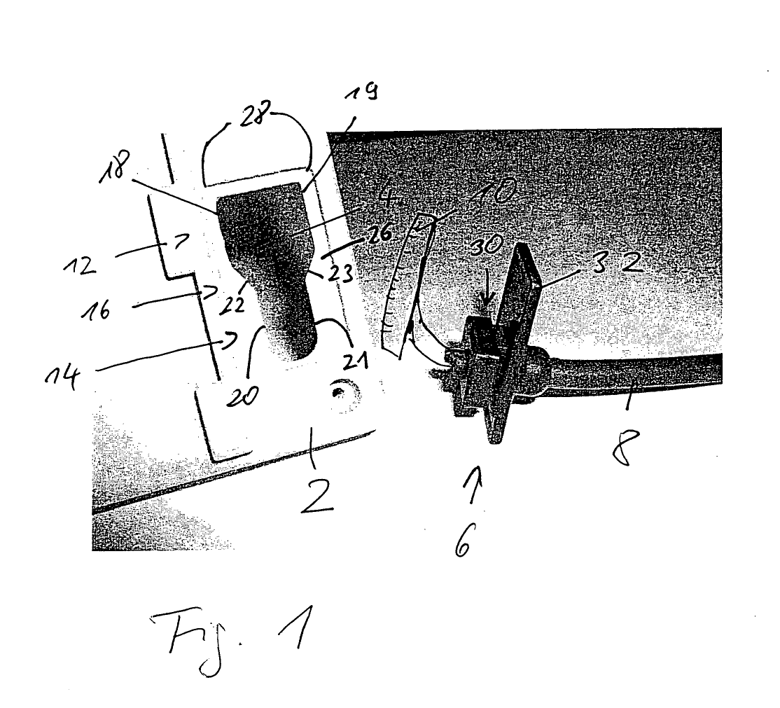

FIG. 1 is a perspective view illustrating an exemplary embodiment of a cable bushing assembly, designated generally as A, according to the invention. Cable bushing assembly A includes a housing wall or panel 2 having an opening 4 to accommodate a cable sleeve fitting 6 affixed to a cable 8. The cable 8 with its sleeve fitting 6, in this view, is shown unmounted. A forward end of the cable 8 is connected to a male plug 10. Cable bushing opening 4 and male plug 10 are dimensioned so that male plug 10 may pass through the cable bushing opening.

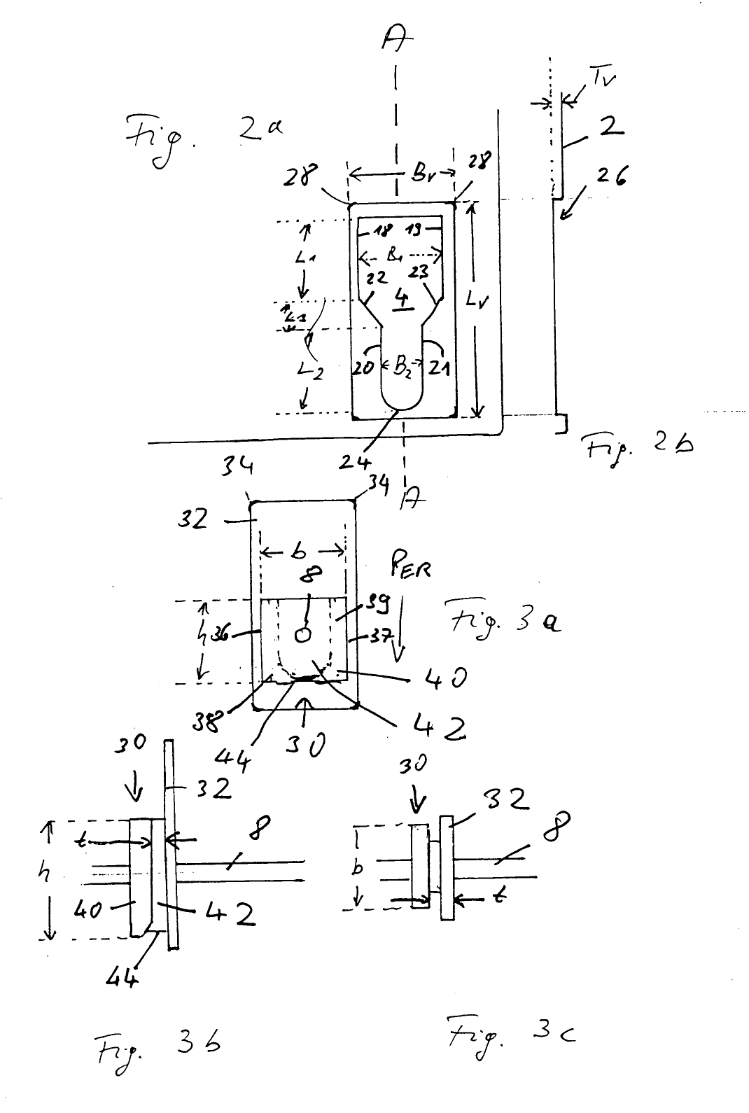

Considering FIG. 2a, in the illustrated embodiment, it is made evident, that cable bushing opening 4 includes a first rectangular area 12, a second area 14, curved at its end remote from the first area 12, and a generally convergent, transition zone 16 between the first and second areas. First area 12 possesses two side edges 18 and 19, which run parallel to one another. In like manner, second area 14 has two parallel running side edges, 20 and 21, which serve as fastening edges. The edges for both areas lie within the same plane.

First area 12 has a width marked as B₁, which defines the distance between side edges 18, 19. The first area has a length, of its rectangular shape, of L₁. Second area 14, which terminates in rounded end 24, has a width designated B₂, which defines the distance between parallel side edges 20, 21. The corresponding length of the second area is L₂. First width B₁ is larger than second width B₂. First length L₁ corresponds to a value approximating that of second length L₂. Transition zone 16 has a third length L₃ and two side edges 22 and 23, which generally converge toward one another. End 24 of the second area, which lies opposite to the transition zone 16 is, in this figure, semicircular. Further as seen in FIG. 2b the entire cable bushing opening 4 lies in a single plane and is placed in a recess 26. Recess 26 is rectangular with rounded-off corners 28, and has a length L_{V}, a width B_{V} and a depth T_{V}.

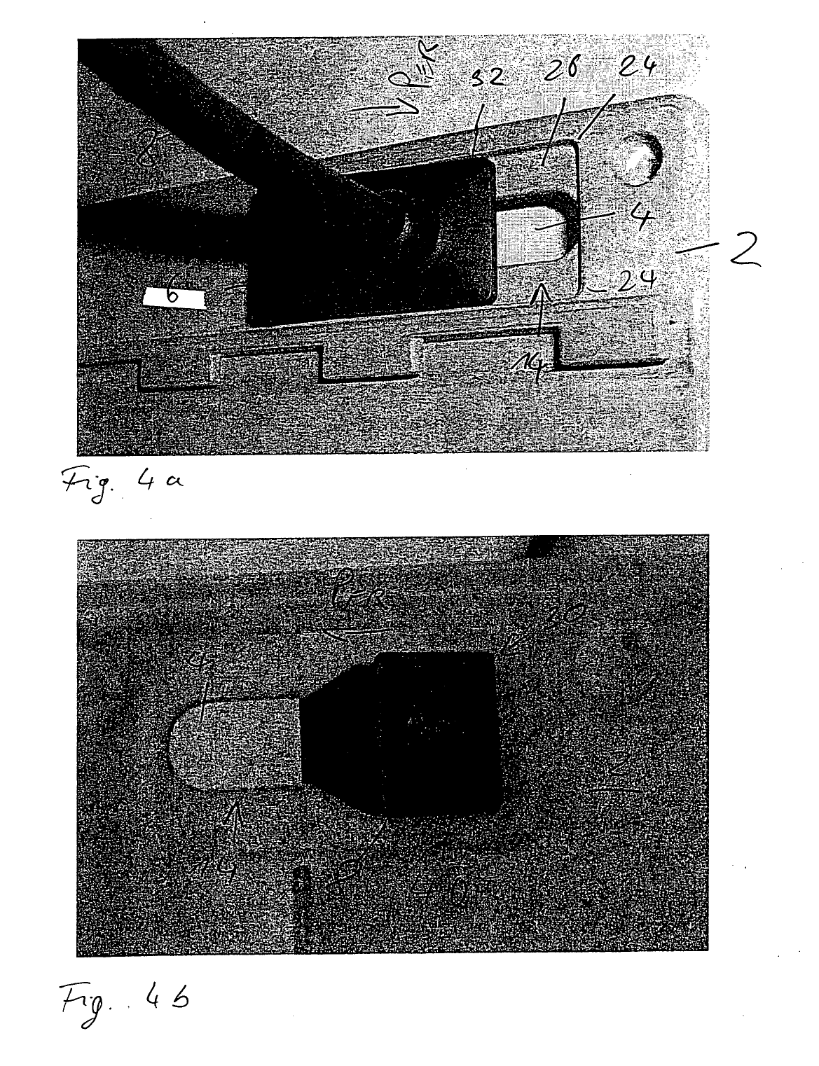

Referring to FIG. 3, sleeve fitting 6 of cable 8 is illustrated in more detail. Sleeve fitting 6 includes a fastening part 30 having a flange cover 32 shown in a plan view 3a. Cover flange 32 is rectangular provided with rounded corners 34. Fastening part 30 has a left and a right side edge 36, 37, respectively. Further, fastening part 30, proximally to side edges 36, 37, has left and a right indentations, designated respectively as 38, 39, along its height (in a longitudinal direction). The combined indentation area of the fastening part 30 provides a securement element 40 having a width b and a length h which, along with a clamping part 42, binds the securement element 40 and the flange cover 32 together. Clamping part 42 has a width B_{K}, which is somewhat larger than the width B₂ of second area 14. The length of the clamping part 42 is equal to the length of securement element 40. The depth t of indentation zones 38, 39 increases along the insertion direction, marked by arrow P_{ER}, of the forward end of clamping part 42 so that a tight wedge of the clamping part occurs at its end. Cable sleeve fitting 6 is composed of a semi-elastic plastic material, for instance, a thermoplastic elastomer. Cable 8 is tightly bound to cable sleeve fitting 6, with particular care taken against the infiltration of moisture.

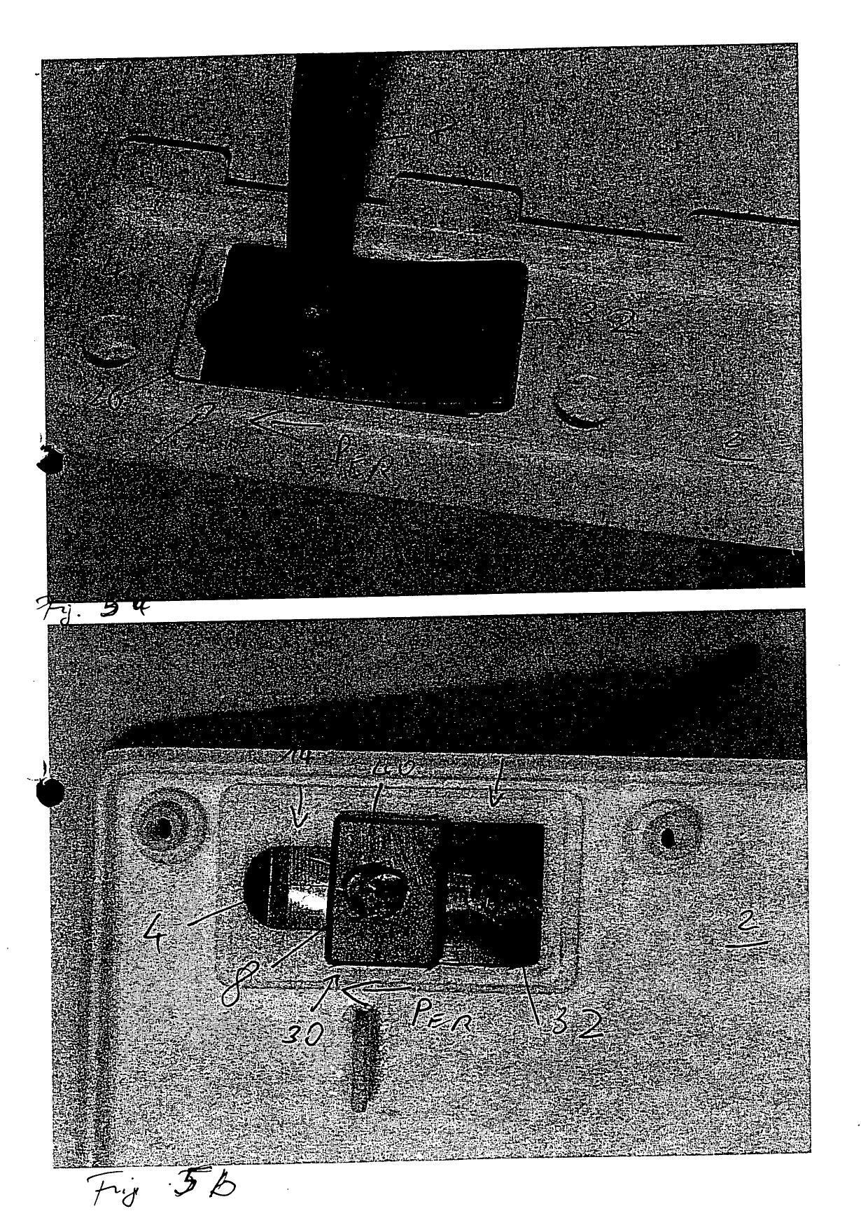

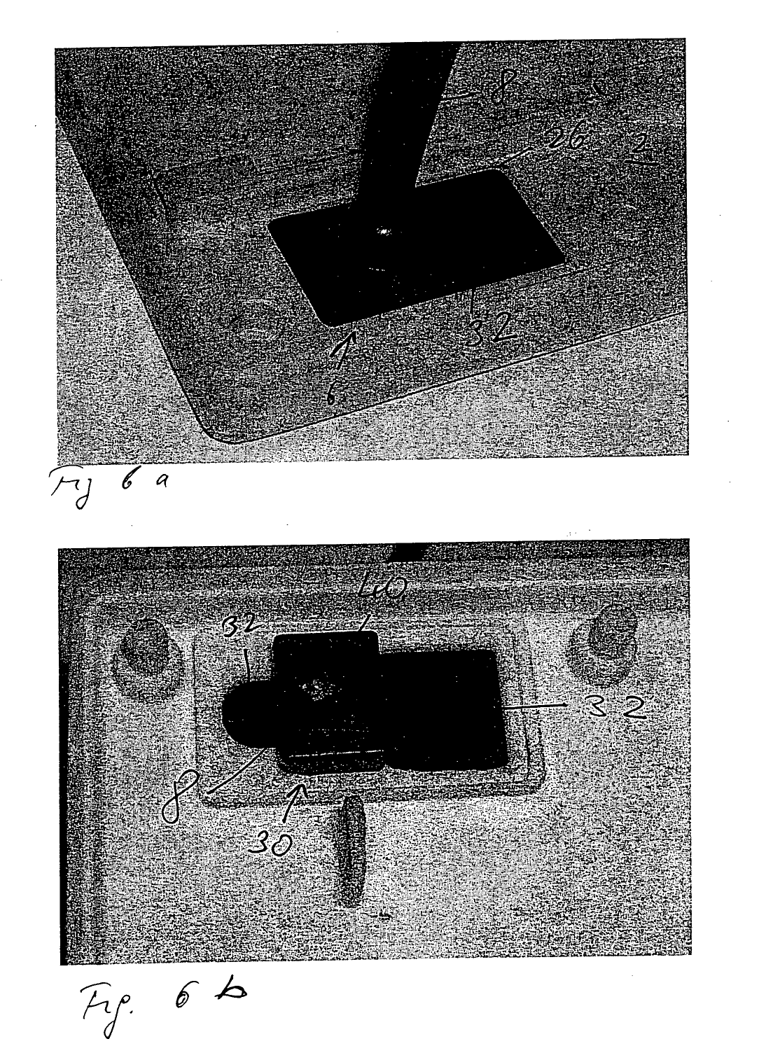

Referring to FIGS. 4 to 6, the mounting of cable 8 with sleeve 8 into cable bushing opening 4 will be described. First, male fitting 10 is passed through cable bushing opening 4, and subsequently fastening part 30 is inserted into first area 12 of the cable bushing opening 4, as shown in FIGS. 4a and 4b. Next, cable sleeve fitting 6 is pushed in the insertion direction marked by arrow P_{ER}, as can be seen in FIGS. 5a, 5b. By means of the tapered transition zone 16, which conveyes in the insertion direction P_{ER}, the insertion and the securement of the clamping piece 42 between fastening edges 20, 21 accomplished. Due to the deeper depth of indentation areas 38, 39 in the insertion direction P_{ER}, starting at forward area 44 of clamping part 42, the insertion of cable sleeve fitting 6 and the clamping part 42 between the fastening edges 20, 21, is made less difficult. By means of this insertion indentations 38, 39 grip into fastening edges 20, 21 and clamping part 42, due to width B_{K} being greater than B₂, and becomes affixed between fastening edges 20, 21. Cable sleeve fitting 6, which is completely forced into second area 14 along with cable 8, is shown in FIGS. 6a and 6b. Forward end 44 of clamping part 42 is complementarily rounded off to fit rounded end 24 of second area 14, so that end 44 makes a tight seal with rounded end 24. Flange cover 32 is arranged in relation to cable 8 and fastening part 30 that, in the case of cable sleeve fitting 6 being completely inserted into second area 14, flange cover 32 totally covers cable bushing opening 4 and occupies recess 26. Since recess 26 is complementary to flange cover 32, the fit of flange cover 32 in the recess is tight.

The tightness in regard to dust and moisture of the cable sleeve fitting is equal to, or better than the protection class IP44 (IP Protective Classification for Apparatuses in Correspondingly Pollution-Loaded Environments).

In the exemplary embodiment, cable 8 penetrates the cable bushing opening 4 perpendicularly and also exits in a perpendicular direction outside of housing panel 2. Alternatively, a penetration in other than a perpendicular direction for cable 8 through bushing opening 4 is possible, and also outside of, or within housing panel 2 it is possible for the cable to penetrate in optimal directions which are angular to the perpendicular directions.

While a preferred embodiment of the invention has been described using specific terms, such description is for illustrative purposes only, and it is to be understood that changes and variations may be made without departing from the spirit or scope of the following claims.

What is claimed is:

1. A cable bushing assembly and mounting panel comprising:
a cable bushing opening in said panel having a first area with a first width and a first length, and a second area with a second width and a second length;
said first width being greater than said second width;
said second area having opposed side edges providing fastening edges;
a cable for routing through said cable bushing opening;
a cable sleeve fitting carried by said cable for mounting in said cable busing opening;
said sleeve fitting including a flange cover through which said cable is routed and which generally overlays said cable bushing opening;
a fastening part carried by said sleeve fitting having a width generally equal to, or less than, said first width of said first area and generally greater than said second width of said second area of said cable bushing opening, and said fastening part having a height which is less than said first length of said first area of said cable bushing opening;
said fastening part having oppositely disposed indentation zones along said height so that said fastening part can be slidably inserted into said second area of said cable bushing opening; and said flange cover protects said fastening part.

2. The cable bushing of claim 1 wherein said cable bushing opening is provided with a recess having a depth and shape complementary to an outer shape of said flange cover.

3. The assembly of claim 2 wherein said flange cover includes a thickness approximately equal to said depth of recess of said cable bushing opening.

4. The assembly of claim 1 wherein said fastening edges extend parallel to one another.

5. The assembly of claim 4 wherein said first area includes opposed side edges extending parallel to one another at a spaced distance defining said first width.

6. The assembly of claim 1 wherein said cable bushing opening includes a transition zone between said first and second area which tapers from said first width to said second width.

7. The assembly of claim 6 wherein transition zone tapers in a generally V-shape toward said second area.

8. The assembly of claim 7 wherein said second area is rounded off at an end remote from said transition zone.

9. The assembly of claim 1 wherein said first area of said cable bushing opening is shaped complementarily to said fastening part.

10. The assembly of claim 9 wherein said first area of said cable bushing opening is rectangular.

11. The assembly of claim 10 wherein said fastening part is rectangular.

12. The assembly of claim 1 wherein a free end of said cable includes a plug connector.

13. The assembly of claim 12 wherein said plug connector has cross-section greater than a cross-section of said cable.

14. The assembly of claim 1 wherein said indentation zones have a depth that is greater on a forward end of said fastening part which faces in an insertion direction of said fastening part.

15. The assembly of claim 1 wherein said cable passes through said flange cover eccentrically.

16. A cable fitting for a cable bushing assembly having a mount with a cable bushing opening comprising:
a cable sleeve fitting;
a cable carried by said sleeve and routed through said sleeve;
a flange cover carried by said sleeve extending transversely to said cable for overlaying at least a part of a cable bushing opening through which said cable is routed;
a fastening part carried by said sleeve having a width and a height;
indentions formed along a height of said fastening part extending parallel to one another for insertion into a depth of fastening edges of the cable bushing opening;
whereby said flange cover surmounts said fastening part and said cable passes through said flange cover.

17. The device of claim 16 wherein said fastening part is rectangular.

18. The device of claim 16 wherein said depth of said indentations of the fastening part is greater on a forward end of said fastening part in an insertion direction of said fastening part.

19. A mounting panel for mounting a cable bushing assembly having a cable sleeve fitting comprising:
a cable bushing opening having a first area with a first width and a first length; and a second area with a second width and a second length;
said first width being greater than said second width; and
said second area having opposed fastening edges for securement of said cable sleeve fitting.

20. The device of claim 19 wherein said cable bushing opening is formed in a recess having a prescribed depth.

21. The device of claim 19 wherein said fastening edges extend parallel to one another.

22. The device of claim 21 wherein said first area of said cable bushing opening includes opposed side edges which extend parallel to one another at a spaced distance defining said first width.

23. The device of claim 22 wherein said cable bushing opening includes a transition zone between said first and second area tapered from said first width to said second width.

24. The device of claim 23 wherein said transition area of said cable bushing opening tapers in a truncated V-shape.

25. The device of claim 23 wherein said second are of said cable bushing opening includes a rounded end remote from said transition area.
